(19) United States
(12) Patent Application Publication
(10) Pub. No.: US 2025/0073631 A1
(43) Pub. Date: Mar. 6, 2025

(54) SYSTEMS FOR ADSORBER REGENERATION AND ASSOCIATED METHODS

(71) Applicant: Gevo, Inc., Englewood, CO (US)

(72) Inventors: Adriano Galvez, III, Englewood, CO (US); Paul Starkey, Englewood, CO (US)

(21) Appl. No.: 18/819,356

(22) Filed: Aug. 29, 2024

Related U.S. Application Data
(60) Provisional application No. 63/580,642, filed on Sep. 5, 2023.

(51) Int. Cl. B01D 53/04

(52) U.S. Cl. CPC B01D 53/0438; B01D 2257/504; B01D 2259/40092; B01D 2259/403

(57) ABSTRACT

A method for removing a target impurity substance from a main process flow by a regenerate material and associated systems are provided. In some embodiments, the method includes (1), directing an input flow from the main process flow to a parallel structure of components; (2) introducing the regenerate material, by the parallel structure, to the input flow to generate an impurity laden regenerate flow; (3) cooling the impurity laden regenerate flow to generate a cooled regenerate flow; (4) cleaning up the cooled regenerate flow to generate a clean regenerate flow.

### CROSS-REFERENCE TO RELATED APPLICATION

This application claims the benefit of co-pending U.S. Provisional Patent Application No. 63/580,642, filed Sep. 5, 2023, the entire contents of these applications are incorporated by reference herein.

### TECHNICAL FIELD

The present disclosure relates to systems for regenerating adsorbers and associated methods. More specifically, a system for removing “target impurity” substances from a main process flow by one or more regenerable, efficient adsorbers. A regenerate material for these adsorbers can be condensed, cleaned-up, and vaporized/heated and then be recycled back to the main process.

### BACKGROUND

In chemical processes, such as refinery-fuel production process, carbon footprints and energy efficiencies are key factors to consider for environmental-sensible manufacturer or producers. For example, conventional processes are not efficient and require additional cost to facilitate the processes. The conventional processes are not energy efficient and do not have a low carbon intensity (CI) score. Therefore, it is advantageous to have an improved system to address the foregoing needs.

### SUMMARY

The present disclosure provides systems for regenerating adsorbers and associated methods. The present system is configured to regenerate target impurity substances in adsorbers (e.g., carbon monoxide, CO, carbon dioxide, CO₂, and/or water) of a main process flow (e.g., an ETJ (Ethanol-to-Jet) production flow). Embodiments of the target impurity substances can include, for example, oxygenated compounds such as alcohols, ketones, aldehydes, as well as nitrogen compounds such as ammonia, acetonitrile, and/or pyrazines.

The present system can include (1) a condensing/cooling module; (2) a regenerate (or “cleaning-up”) module; and (3) a vaporizing/heating module. The condensing/cooling module is configured to cool an impurity laden process flow. The regenerate module is configured to regenerate or “clean-up” the cooled impurity laden process flow. The present system also uses a “regenerate” material to remove the target impurity substances. Examples of the “regenerate” material include a renewable naphtha (e.g., a flammable liquid hydrocarbon mixture, etc.). The vaporizing/heating module is configured to heat, and in some cases vaporize, the cleaned process flow.

In some embodiments, the regenerate module can perform a distillation process for the regenerate material. In some embodiments, the regenerate module can (A) dispose separated impurity to an appropriate destination, such as flare, closed drain, fuel gas, etc.; (B) purge the regenerate material back to a product process or the main process flow, such that it can be used in other places; (C) add a supplemental material so as to address a potential degradation of the regenerate material over time.

In some embodiments, the regenerate material can be a naphtha. In some embodiments, the regenerate material can be an SAF (sustainable aviation fuel) product. In some embodiments, the regenerate material can be alkanes with low olefin content (e.g., less than one percent weight percentage). In other embodiments, the regenerate material can be a renewable alkylate produce, isobutane, etc.

The vaporizing/heating module is configured to heat or vaporize a cleaned regenerated material (i.e., processed by the regenerate module) so as to form a hot regenerate vapor that can be later directed back to the main process flow.

In some embodiments, the system can have a parallel structure of dryers or other adsorbers (e.g., CO₂ adsorbers) before the condensing process performed by the condensing/cooling module and after the vaporizing/heating process performed by the vaporizing/heating module. Embodiments of the parallel structure are discussed in detail with reference to FIGS. 3 and 4.

The present systems and methods are not limited only to ETJ processes. In some embodiments, the present systems and methods can be applied in Alcohol-to-Jet (ATJ) and/or Alcohol-to-Hydrocarbons (ATH) processes. In some embodiments, the present methods and systems can be implemented for systems fed with “non-ethanol” alcohols (e.g., isobutanol) and for other products such as high octane gasoline and renewable diesel.

In some embodiments, the present method can be implemented by a tangible, non-transitory, computer-readable medium having processor instructions stored thereon that, when executed by one or more processors, cause the one or more processors to perform one or more aspects/features of the method described herein. In other embodiments, the present method can be implemented by a system comprising a computer processor and a non-transitory computer-readable storage medium storing instructions that when executed by the computer processor cause the computer processor to perform one or more actions of the method described herein.

### BRIEF DESCRIPTION OF THE DRAWINGS

To describe the technical solutions in the implementations of the present disclosure more clearly, the following briefly describes the accompanying drawings. The accompanying drawings show merely some aspects or implementations of the present disclosure, and a person of ordinary skill in the art may still derive other drawings from these accompanying drawings without creative efforts.

FIG. 1 is a schematic diagram of a present system in accordance with one or more implementations of the present disclosure.

FIG. 2 is a schematic diagram describing a process flow of the present system in accordance with one or more implementations of the present disclosure.

FIGS. 3A and 3B are schematic diagrams showing a parallel structure of CO₂ adsorbers and associated components of the present system in accordance with one or more implementations of the present disclosure.

FIGS. 4A and 4B are schematic diagrams showing a parallel structure of dryers and associated components of the present system in accordance with one or more implementations of the present disclosure.

FIG. 5 is a flowchart of a method in accordance with one or more implementations of the present disclosure.

FIG. 6 is a block diagram a computing device that can be used to implement the methods disclosed herein in accordance with one or more implementations of the present disclosure.

### DETAILED DESCRIPTION

To describe the technical solutions in the implementations of the present disclosure more clearly, the following briefly describes the accompanying drawings. The accompanying drawings show merely some aspects or implementations of the present disclosure, and a person of ordinary skill in the art may still derive other drawings from these accompanying drawings without creative efforts.

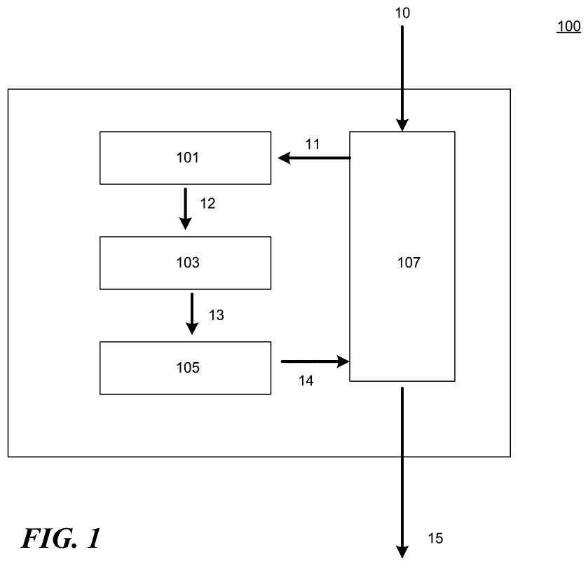

FIG. 1 is a schematic diagram of a present system 100 in accordance with one or more implementations of the present disclosure. The system 100 includes a condensing/cooling module 101; a regenerate (or “cleaning-up”) module 103; and a vaporizing/heating module 105. The system 100 also includes a parallel structure 107 of adsorbers/dryers configured to receive an input flow 10 from a main process flow (e.g., an ETJ production flow).

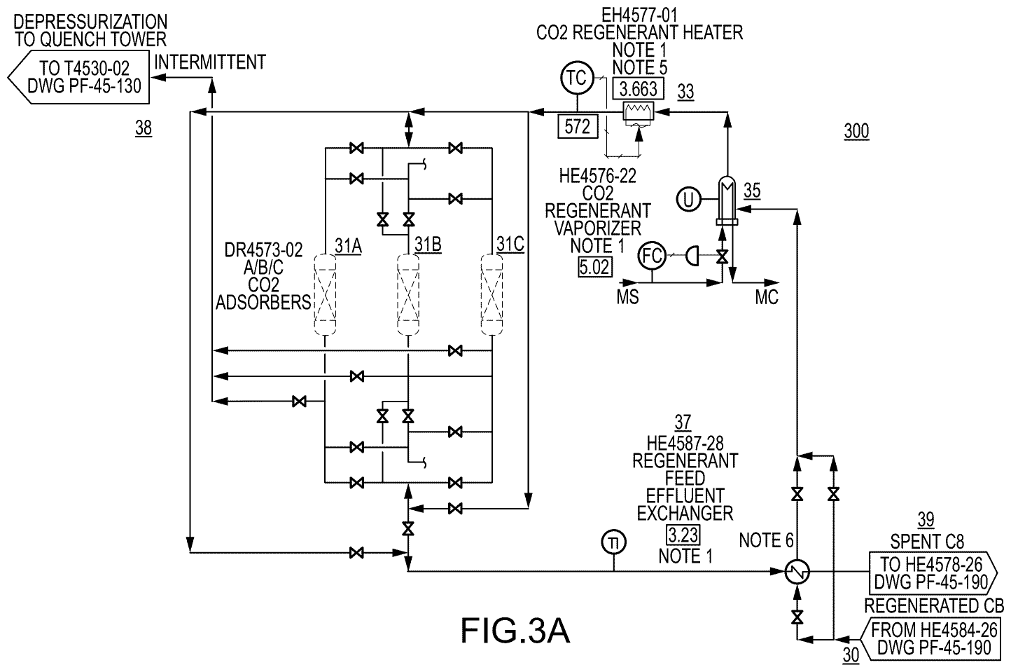

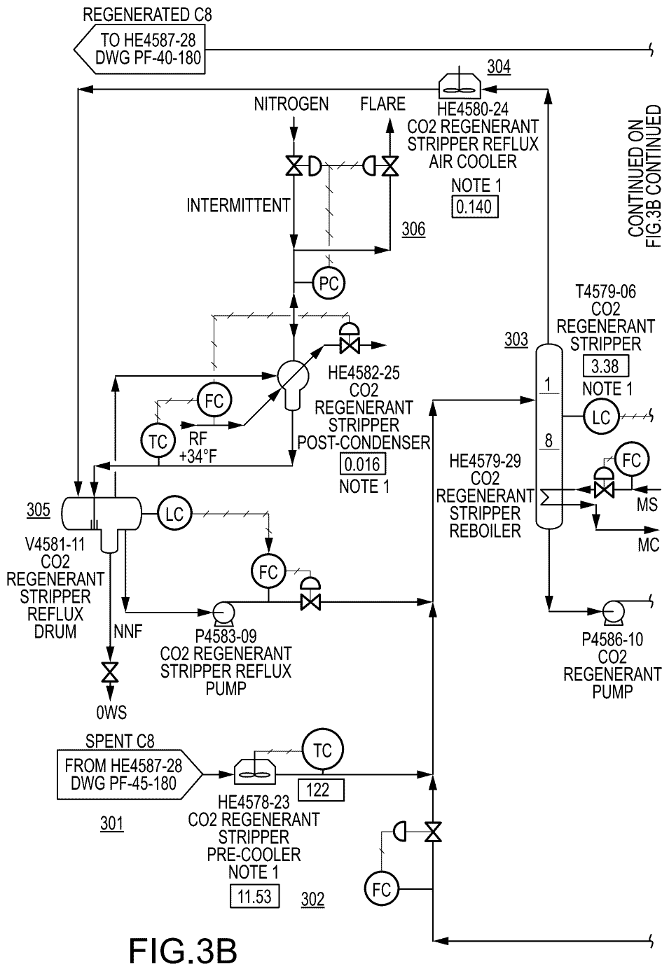

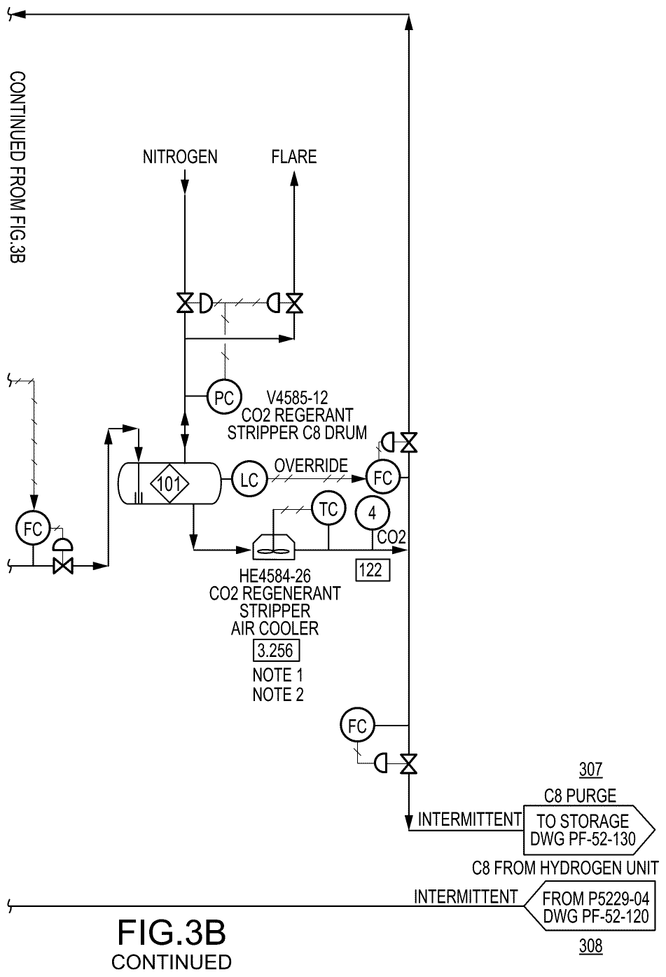

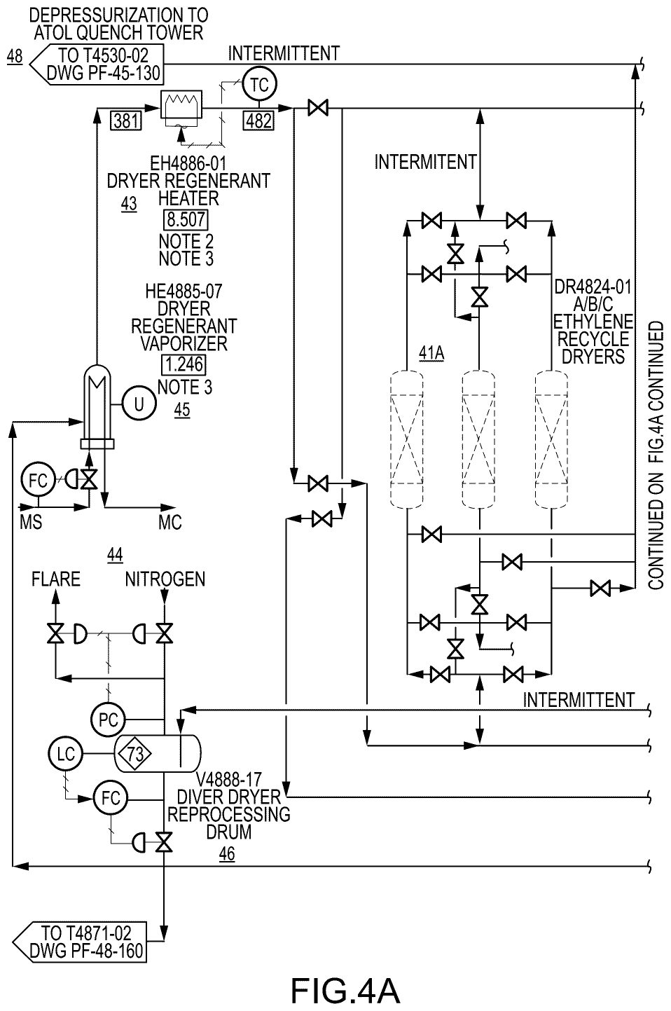

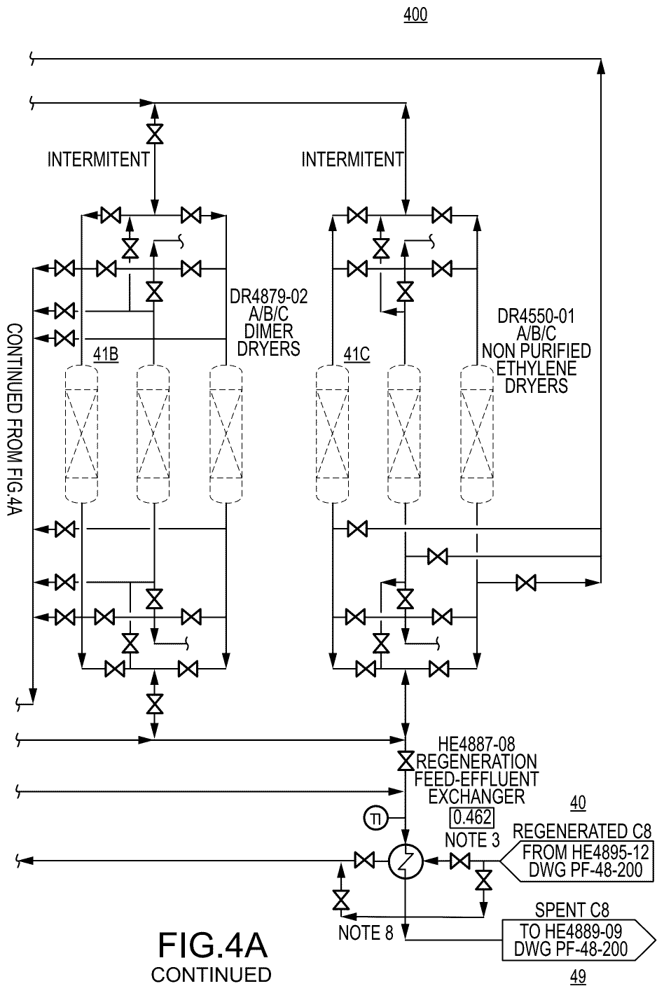

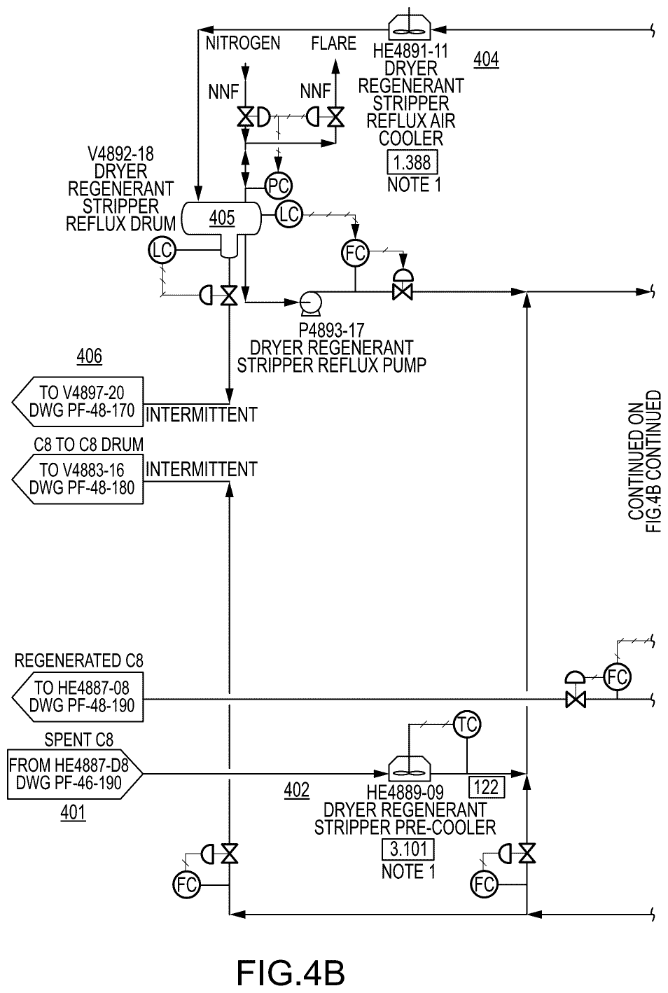

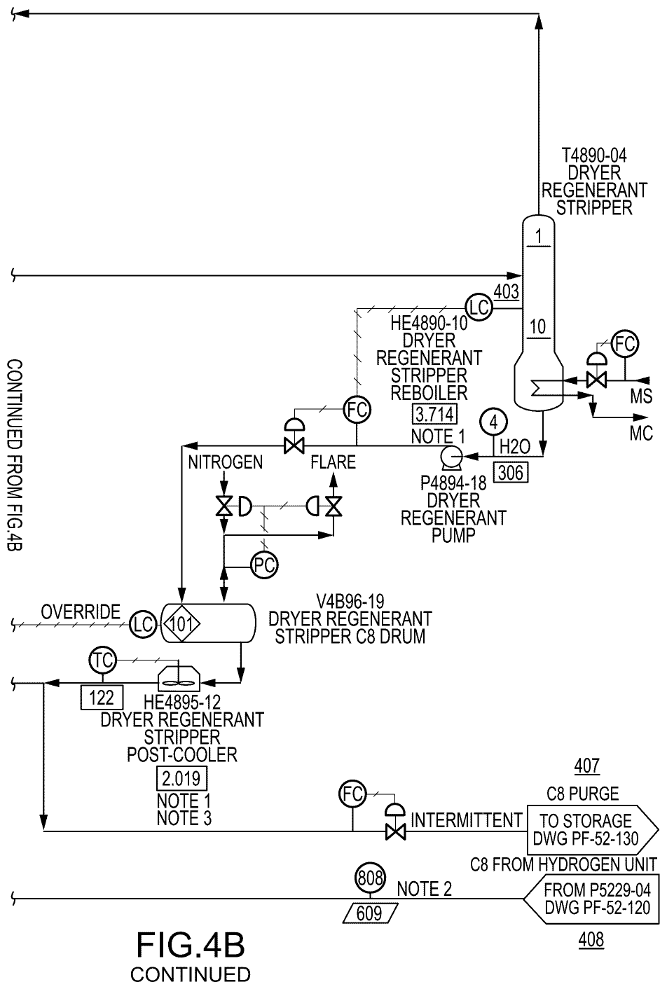

Embodiments of the parallel structure 107 are discussed in detail with reference to FIGS. 3 and 4. Advantages of the parallel structure 107 at least include (i) design flexibility; (ii) a system capability of fine-tuning operating parameters such as temperature, pressures, duration, etc.; (iii) system reliability (e.g., when one dryer is under maintenance or interrupted, the other dryers can still function).

The system 100 is configured to remove or “regenerate” target impurity substances in the adsorbers/dryers. Embodiments of the target impurity substances can include, for example, carbon monoxide (CO) carbon dioxide (CO₂), water, oxygenated compounds such as alcohols, ketones, aldehydes, as well as nitrogen compounds such as ammonia, acetonitrile, and/or pyrazines.

The system 100 uses a regenerate material as a “carrier” throughout the processes of the condensing/cooling module 101; the regenerate module 103; and the vaporizing/heating module 105. In some embodiments, the regenerate material can be a naphtha (e.g., a flammable liquid hydrocarbon mixture, etc.). In some embodiments, the regenerate material can be an SAF (sustainable aviation fuel) product. In some embodiments, the regenerate material can be alkanes with low olefin content (e.g., less than one percent weight percentage). In other embodiments, the regenerate material can be a renewable alkylate product, isobutane, butanes, etc.

The parallel structure 107 of adsorbers/dryers processes the input flow 10 and introduce the regenerate material and generates an impurity laden regenerate flow 11. The condensing/cooling module 101 is then configured to cool the impurity laden regenerate flow 11 and form a cooled regenerate flow 12.

The regenerate module 103 is then configured to regenerate or “clean-up” the cooled regenerate flow 12 and generate a clean regenerate process flow 13.

In some embodiments, the regenerate module 103 can perform a distillation process for the regenerate material. In some embodiments, the regenerate module 103 can perform three sub-steps: (A) disposing separated impurity to an appropriate destination, such as flare, closed drain, fuel gas, etc.; (B) purging the regenerate material back to a product process or the main process flow, such that it can be used in the main process flow; (C) adding a supplemental material (e.g., well-saturated alkane) so as to prevent or mitigate a potential degradation of the regenerate material over time.

The vaporizing/heating module 105 is configured to heat the cleaned regenerate process flow 13 and generates a hot regenerate vapor 14 that can be later directed back to the main process flow as an output flow 15 of the system 100.

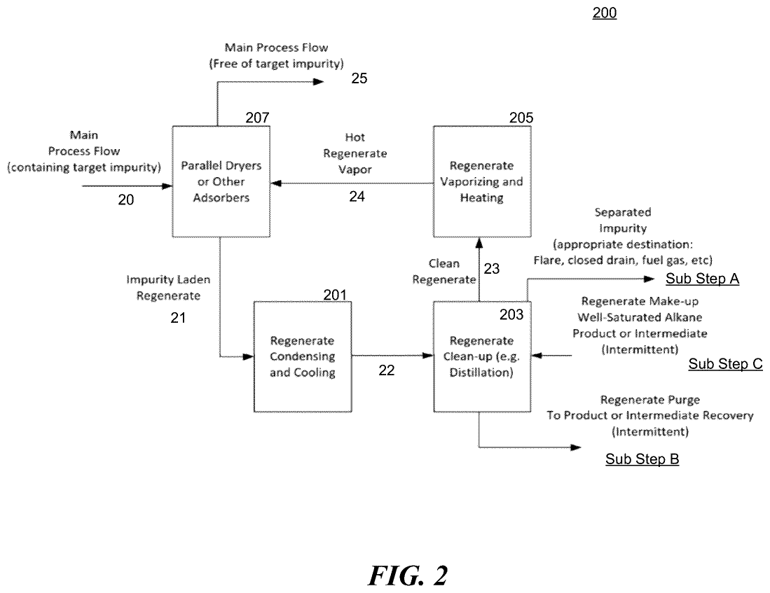

FIG. 2 is a schematic diagram describing a process flow 200 of the present system 100 in accordance with one or more implementations of the present disclosure. As shown, a parallel structure 207 of adsorbers/dryers is configured to receive an input flow 20 from a main process flow (e.g., an ETJ production flow) and remove or “regenerate” target impurity substances. The parallel structure 207 of adsorbers/dryers introduces a regenerate material to the system so as to facilitate the absorbing process.

Embodiments of the target impurity substances can include, for example, carbon monoxide (CO) carbon dioxide (CO₂), water, oxygenated compounds such as alcohols, ketones, aldehydes, as well as nitrogen compounds such as ammonia, acetonitrile, and/or pyrazines. Embodiments of the regenerate material include a renewable naphtha, an SAF (sustainable aviation fuel) product, alkanes with low olefin content (e.g., less than one percent weight percentage), a renewable alkylate product, isobutane, etc.

The parallel structure 207 of adsorbers/dryers processes the input flow 20 and introduces the regenerate material and generate an impurity laden regenerate flow 21. A condensing/cooling module 201 then cools the impurity laden regenerate flow 21 and forms a cooled regenerate flow 22. A regenerate module 203 regenerates or “cleans-up” the cooled regenerate flow 22 and generates a clean regenerate 23.

In some embodiments, the regenerate module 203 can perform a distillation process for the regenerate material. In some embodiments, the regenerate module 203 can perform three sub-steps: (A) disposing separated impurity to an appropriate destination, such as flare, closed drain, fuel gas, etc.; (B) purging the regenerate material back to a product process or the main process flow, such that it can be used in the main process flow; (C) adding a supplemental material (e.g., well-saturated alkane) so as to prevent or mitigate a potential degradation of the regenerate material over time.

A vaporizing/heating module 205 then heats the cleaned regenerate 23 and generates a hot regenerate vapor 24 that can be later directed back to the main process flow as an output flow 25.

FIGS. 3A and 3B are schematic diagrams showing a parallel structure 300 of CO₂ adsorbers and associated components of the present system in accordance with one or more implementations of the present disclosure. As shown in FIG. 3A, three CO₂ adsorbers 31A-C are arranged in parallel and in fluid communication with a heater 33, and a vaporizer 35, respectively. An effluent exchanger 37 is configured to regulate incoming flow 30 and outgoing flow 39. In some embodiments, the effluent exchanger 37 is configured to condense and cool a regenerate material on its way to a regenerate module for clean-up. The exchanger 37 can also recover heat from a dirty, hot regenerate vapor and transfer it to a clean, liquid regenerate material. The exchanger 37 provides a means of conserving heat so as to reduce energy consumption (e.g., steam and cooling water). The three CO₂ adsorbers 31A-C are also coupled to an outlet 38 for an intermittent regenerate process.

In FIG. 3B, a CO₂ (i.e., “impurity” in this embodiment) regenerant stripping process is described. First, a CO₂ laden regenerate can be directed from an input 301. The CO₂ laden regenerate can be cooled at a cooling component 302. The cooled CO₂ laden regenerate can be directed to a boiler 303 (where a portion of the CO₂ is removed or “stripped” from the regenerate). The stripped CO₂ can be cooled at a cooler 304, directed to a reflux drum 305, and then directed to a flare component 306 such that the stripped CO₂ can be burned (e.g., Sub Step A shown in FIG. 2).

As also shown in FIG. 3B, after the process at the boiler 303, the regenerate separated from the stripped CO₂ can be directed to a component 307, where the regenerate can be purged back to the system for further process (e.g., Sub Step B shown in FIG. 2). In some embodiments, a regenerate make-up process can be performed (from a component 308 to the boiler 303) such that the regenerate can be regenerated (e.g., Sub Step C shown in FIG. 2)

FIGS. 4A and 4B are schematic diagrams showing a parallel structure 400 of dryers and associated components of the present system in accordance with one or more implementations of the present disclosure. As shown in FIG. 4A, three sets of dryers 41A-C (each set has three individual dryers also arranged in parallel) are arranged in parallel and in fluid communication with a heater 43 and a vaporizer 45, respectively. An effluent exchanger 48 is configured to regulate incoming flow 40 and outgoing flow 49. In some embodiments, the effluent exchanger 48 is configured to condense and cool a regenerate material on its way to a regenerate module for clean-up. The exchanger 48 can also recover heat from a dirty, hot regenerate vapor and transfer it to a clean, liquid regenerate material. The exchanger 48 provides a means of conserving heat so as to reduce energy consumption (e.g., steam and cooling water). The three sets of dryers 41A-C are also coupled to an outlet 8 for an intermittent regenerate process. The three sets of dryers 41A-C are also coupled to a reprocessing drum in case there is a need for a regenerate “mark-up” process (e.g., Sub Step C shown in FIG. 2). Separated impurity can be directed to a proper location 44 (e.g., Sub Step A shown in FIG. 2).

In FIG. 4B, a moisture/water (i.e., “impurity” in this embodiment) regenerant stripping process is described. First, a moisture laden regenerate can be directed from an input 401. The moisture laden regenerate can be cooled at a cooling component 402. The cooled moisture laden regenerate can be directed to a boiler 403 (where a portion of the moisture is removed or “stripped” from the regenerate). The stripped moisture can be cooled at a cooler 404, directed to a reflux drum 405, and then directed to a flare component 406 such that the stripped moisture can be processed (e.g., Sub Step A shown in FIG. 2).

As also shown in FIG. 4B, after the process at the boiler 403, the regenerate separated from the stripped moisture can be directed to a component 407, where the regenerate can be purged back to the system for further process (e.g., Sub Step B shown in FIG. 2). In some embodiments, a regenerate make-up process can be performed (from a component 408 to the boiler 403) such that the regenerate can be regenerated (e.g., Sub Step C shown in FIG. 2)

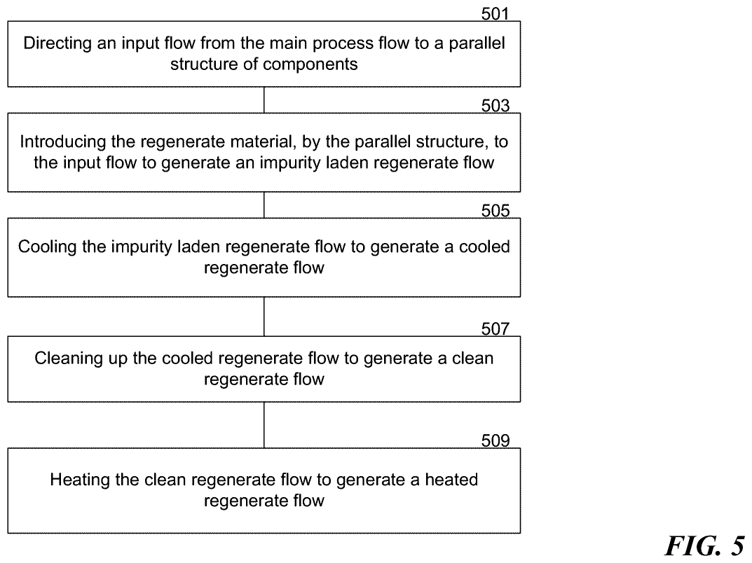

FIG. 5 is a flowchart of a method for removing a target impurity substance from a main process flow by a regenerate material. The method 500 includes, at block 501, directing an input flow from the main process flow to a parallel structure of components. In some embodiments, the components can include three carbon monoxide (CO₂) adsorbers. In some embodiments, the components can include three sets of dryers (e.g., each set has three individual dryers). In some embodiment a CO₂ adsorber and a dryer can be arranged in series. In some embodiments, only two adsorbers are used to cover the regeneration cycles described herein. In some embodiments, more than three adsorbers can be used in parallel to cover the regeneration cycles. In some embodiments there can be two or more oxygenate adsorbers in parallel. In some embodiments, there can be two or more nitrogen compound adsorbers in parallel. In some embodiments, any combination of nitrogen compounds, oxygenates, CO₂ and water can be adsorbed in the same adsorbers.

At block 503, the method 500 continues by introducing the regenerate material, by the parallel structure, to the input flow to generate an impurity laden regenerate flow. In some embodiments, the regenerate material can include a renewable naphtha, a Sustainable Aviation Fuel (SAF) product, a renewable alkylate, a renewable isobutane, etc.

At block 505, the method 500 continues by cooling the impurity laden regenerate flow to generate a cooled regenerate flow. At block 507, the method 500 continues by cleaning up the cooled regenerate flow to generate a clean regenerate flow. At block 509, the method 500 continues by heating the clean regenerate flow to generate a heated regenerate flow.

In some embodiments, the “cleaning up” step can include a few sub steps, such as (1) performing a distillation process for the cooled regenerate flow; (2) disposing separated impurity to an appropriate destination; (3) purging at least a portion of the regenerate material in the cooled regenerate flow back to the main process flow; (4) adding a supplemental material to the cooled regenerate flow.

In some embodiments, the supplemental material can include a well-saturated alkane. In some embodiments, the supplemental material can include a alkanes with less than one percent olefin content in weight.

In some embodiments, the method 500 can further include steps of directing the heated regenerate flow to the parallel structure to generate an output flow; and directing the output flow to the main process flow.

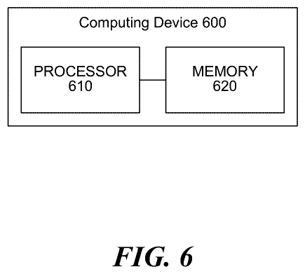

FIG. 6 is a schematic block diagram of a computing device 600 (e.g., which can implement the methods discussed herein) in accordance with one or more implementations of the present disclosure. As shown, the computing device 600 includes a processing unit 610 (e.g., a DSP, a CPU, a GPU, etc.) and a memory 620. The processing unit 610 can be configured to implement instructions that correspond to the methods discussed herein and/or other aspects of the implementations described above. It should be understood that the processor 610 in the implementations of this technology may be an integrated circuit chip and has a signal processing capability. During implementation, the steps in the foregoing method may be implemented by using an integrated logic circuit of hardware in the processor 610 or an instruction in the form of software. The processor 610 may be a general-purpose processor, a digital signal processor (DSP), an application specific integrated circuit (ASIC), a field programmable gate array (FPGA) or another programmable logic device, a discrete gate or transistor logic device, and a discrete hardware component. The methods, steps, and logic block diagrams disclosed in the implementations of this technology may be implemented or performed. The general-purpose processor 610 may be a microprocessor, or the processor 610 may be alternatively any conventional processor or the like. The steps in the methods disclosed with reference to the implementations of this technology may be directly performed or completed by a decoding processor implemented as hardware or performed or completed by using a combination of hardware and software modules in a decoding processor. The software module may be located at a random-access memory, a flash memory, a read-only memory, a programmable read-only memory or an electrically erasable programmable memory, a register, or another mature storage medium in this field. The storage medium is located at a memory 620, and the processor 610 reads information in the memory 620 and completes the steps in the foregoing methods in combination with the hardware thereof.

It may be understood that the memory 620 in the implementations of this technology may be a volatile memory or a non-volatile memory, or may include both a volatile memory and a non-volatile memory. The non-volatile memory may be a read-only memory (ROM), a programmable read-only memory (PROM), an erasable programmable read-only memory (EPROM), an electrically erasable programmable read-only memory (EEPROM) or a flash memory. The volatile memory may be a random-access memory (RAM) and is used as an external cache. For exemplary rather than limitative description, many forms of RAMs can be used, and are, for example, a static random-access memory (SRAM), a dynamic random-access memory (DRAM), a synchronous dynamic random-access memory (SDRAM), a double data rate synchronous dynamic random-access memory (DDR SDRAM), an enhanced synchronous dynamic random-access memory (ESDRAM), a synchronous link dynamic random-access memory (SLDRAM), and a direct Rambus random-access memory (DR RAM). It should be noted that the memories in the systems and methods described herein are intended to include, but are not limited to, these memories and memories of any other suitable type. In some embodiments, the memory may be a non-transitory computer-readable storage medium that stores instructions capable of execution by a processor.

### ADDITIONAL CONSIDERATIONS

The above Detailed Description of examples of the disclosed technology is not intended to be exhaustive or to limit the disclosed technology to the precise form disclosed above. While specific examples for the disclosed technology are described above for illustrative purposes, various equivalent modifications are possible within the scope of the described technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative implementations or sub-combinations. Each of these processes or blocks may be implemented in a variety of different ways. Also, while processes or blocks are at times shown as being performed in series, these processes or blocks may instead be performed or implemented in parallel, or may be performed at various times. Further, any specific numbers noted herein are only examples; alternative implementations may employ differing values or ranges.

In the Detailed Description, numerous specific details are set forth to provide a thorough understanding of the presently described technology. In other implementations, the techniques introduced here can be practiced without these specific details. In other instances, well-known features, such as specific functions or routines, are not described in detail in order to avoid unnecessarily obscuring the present disclosure. References in this description to “an implementation/embodiment,” “one implementation/embodiment,” or the like mean that a particular feature, structure, material, or characteristic being described is included in at least one implementation of the described technology. Thus, the appearances of such phrases in this specification do not necessarily all refer to the same implementation/embodiment. On the other hand, such references are not necessarily mutually exclusive either. Furthermore, the particular features, structures, materials, or characteristics can be combined in any suitable manner in one or more implementations/embodiments. It is to be understood that the various implementations shown in the figures are merely illustrative representations and are not necessarily drawn to scale.

Several details describing structures or processes that are well-known and often associated with communications systems and subsystems, but that can unnecessarily obscure some significant aspects of the disclosed techniques, are not set forth herein for purposes of clarity. Moreover, although the following disclosure sets forth several implementations of various aspects of the present disclosure, several other implementations can have different configurations or different components than those described in this section. Accordingly, the disclosed techniques can have other implementations with additional elements or without several of the elements described below.

Many implementations or aspects of the technology described herein can take the form of computer-or processor-executable instructions, including routines executed by a programmable computer or processor. Those skilled in the relevant art will appreciate that the described techniques can be practiced on computer or processor systems other than those shown and described below. The techniques described herein can be implemented in a special-purpose computer or data processor that is specifically programmed, configured, or constructed to execute one or more of the computer-executable instructions described below. Accordingly, the terms “computer” and “processor” as generally used herein refer to any data processor. Information handled by these computers and processors can be presented at any suitable display medium. Instructions for executing computer-or processor-executable tasks can be stored in or on any suitable computer-readable medium, including hardware, firmware, or a combination of hardware and firmware. Instructions can be contained in any suitable memory device, including, for example, a flash drive and/or other suitable medium.

The term “and/or” in this specification is only an association relationship for describing the associated objects, and indicates that three relationships may exist, for example, A and/or B may indicate the following three cases: A exists separately, both A and B exist, and B exists separately.

These and other changes can be made to the disclosed technology in light of the above Detailed Description. While the Detailed Description describes certain examples of the disclosed technology, as well as the best mode contemplated, the disclosed technology can be practiced in many ways, no matter how detailed the above description appears in text. Details of the system may vary considerably in its specific implementation, while still being encompassed by the technology disclosed herein. As noted above, particular terminology used when describing certain features or aspects of the disclosed technology should not be taken to imply that the terminology is being redefined herein to be restricted to any specific characteristics, features, or aspects of the disclosed technology with which that terminology is associated. Accordingly, the invention is not limited, except as by the appended claims. In general, the terms used in the following claims should not be construed to limit the disclosed technology to the specific examples disclosed in the specification, unless the above Detailed Description section explicitly defines such terms.

A person of ordinary skill in the art may be aware that, in combination with the examples described in the implementations disclosed in this specification, units and algorithm steps may be implemented by electronic hardware, or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of this application.

Although certain aspects of the invention are presented below in certain claim forms, the applicant contemplates the various aspects of the invention in any number of claim forms. Accordingly, the applicant reserves the right to pursue additional claims after filing this application to pursue such additional claim forms, in either this application or in a continuing application.

What is claimed is:

1. A method for removing a target impurity substance from a main process flow by a regenerate material, the method comprising:
directing an input flow from the main process flow to a parallel structure of components;
introducing the regenerate material, by the parallel structure, to the input flow to generate an impurity laden regenerate flow;
cooling the impurity laden regenerate flow to generate a cooled regenerate flow;
cleaning up the cooled regenerate flow to generate a clean regenerate flow;
heating the clean regenerate flow to generate a heated regenerate flow; and
directing the heated regenerate flow output from the parallel structure to the main process flow.

2. The method of claim 1, wherein the components include three carbon monoxide (CO₂) adsorbers.

3. The method of claim 1, wherein the components include three sets of dryers.

4. The method of claim 1, wherein the components include nine dryers.

5. The method of claim 1, wherein the regenerate material includes a renewable naphtha.

6. The method of claim 1, wherein the regenerate material includes a Sustainable Aviation Fuel (SAF) product.

7. The method of claim 1, wherein the regenerate material includes a renewable alkylate.

8. The method of claim 1, wherein the regenerate material includes a renewable isobutane.

9. The method of claim 1, wherein cleaning up the cooled regenerate flow includes performing a distillation process for the cooled regenerate flow.

10. The method of claim 1, wherein cleaning up the cooled regenerate flow includes disposing separated impurity to an appropriate destination.

11. The method of claim 1, wherein cleaning up the cooled regenerate flow includes purging at least a portion of the regenerate material in the cooled regenerate flow back to the main process flow.

12. The method of claim 1, wherein cleaning up the cooled regenerate flow includes adding a supplemental material to the cooled regenerate flow.

13. The method of claim 12, wherein the supplemental material includes a well-saturated alkane.

14. The method of claim 12, wherein the supplemental material includes a alkanes with less than one percent olefin content in weight.

15. A system comprising:
a parallel structure of at least one adsorber or at least one dryer configured to receive an input flow from a main process flow and introducing a regenerate material to the input flow to generate an impurity laden regenerate flow;
a cooling module configured to cool the impurity laden regenerate flow and generate a cooled regenerate flow;
a regenerate module configured to regenerate the cooled regenerate flow and generate a clean regenerate process flow; and
a heating module configured to heat the clean regenerate process flow and generate a heated regenerate process flow for the parallel structure of adsorbers to generate an output flow back to the main process flow.

16. The system of claim 15, wherein the components comprise a plurality of (CO₂) adsorbers.

17. The system of claim 15, wherein the components comprise a plurality of dryers.

18. The system of claim 16, wherein the components comprise a plurality of dryers.

19. The system of claim 15, wherein the regenerate module comprises a distiller.

20. A non-transitory computer readable storage medium storing instructions that when executed cause a processor to perform actions comprising:
directing an input flow from a main process flow to a parallel structure of components;
introducing a regenerate material, to the parallel structure, to the input flow to generate an impurity laden regenerate flow;
cooling the impurity laden regenerate flow to generate a cooled regenerate flow;
cleaning up the cooled regenerate flow to generate a clean regenerate flow;
heating the clean regenerate flow to generate a heated regenerate flow; and
directing the heated regenerate flow output, from the parallel structure, to the main process flow.
